(19) United States
(12) Patent Application Publication
(10) Pub. No.: US 2019/0273244 A1
(43) Pub. Date: Sep. 5, 2019

(54) BATTERY CELL HAVING A STRUCTURED ACTIVE MATERIAL

(71) Applicants: ROBERT BOSCH GMBH, Stuttgart (DE); GS YUASA INTERNATIONAL LTD., Kyoto-shi, Kamigyo-ku (JP)

(72) Inventors: Gaetan Deromelaere, Kyoto-shi (JP); Christopher Wille, Stuttgart (DE); Marco Friedrich, Ludwigsburg (DE); Markus Klinsmann, Stuttgart (DE); Cornelius Liebenow, Stuttgart (DE)

(21) Appl. No.: 16/345,575

(22) PCT Filed: Oct. 16, 2017
(86) PCT No.: PCT/EP2017/076287

§ 371 Date: Apr. 26, 2019

(30) Foreign Application Priority Data
Oct. 27, 2016 (EP) 16195976.2

(51) Int. Cl. H01M 4/04; H01M 2/16; H01M 10/0525; H01M 4/36

(52) U.S. Cl. CPC H01M 4/0414; H01M 4/366; H01M 10/0525; H01M 2/1653

(57) ABSTRACT

The invention relates to a battery cell, in particular a lithium ion battery cell, having a cathode (3) comprising a cathode active material (333) and having an anode (1) comprising an anode active material (111), wherein the cathode active material (333) and/or the anode active material (111) is/are structured in such a way that between contiguous cathode active material regions (333a) and/or between contiguous anode active material regions (111a) there are hollow spaces (4) which spatially separate the contiguous cathode active material regions (333a) and/or the contiguous anode active material regions (111a) from one another and wherein the hollow spaces (4) are at least partly filled with an electrically insulating material (5).

The invention relates to a battery cell, a battery comprising the battery cell and to the use of the battery according to the preamble of the independent claims.

### PRIOR ART

A battery cell is an electrochemical energy store which on being discharged converts the stored chemical energy into electric energy by means of an electrochemical reaction. It is apparent that new battery systems which have to meet very demanding requirements in respect of reliability, safety, performance and lifetime will be used in future both in stationary applications such as wind power plants, in motor vehicles which are designed as hybrid or electric motor vehicles and also in electronic appliances. Owing to their high energy density, lithium ion batteries are particularly used as energy stores for electrically powered motor vehicles.

U.S. Pat. No. 8,920,522 B2 discloses an active material of a negative electrode, where the surface of the active material has an uneven pattern so that the surface of the active material layer is made larger.

U.S. Pat. No. 8,685,560 B2 discloses subcells, where each subcell has a plurality of electrolyte layers and also one or more conductive structures which are at least partly covered with active material and have lead-throughs.

### DISCLOSURE OF THE INVENTION

The invention provides a battery cell, in particular a lithium ion battery cell, having a cathode comprising a cathode active material and having an anode comprising an anode active material, and also a battery and its use, having the characterizing features of the independent claims.

Lithium ion battery cells comprise at least one anode and at least one cathode which can reversibly incorporate and release lithium ions. Furthermore, lithium ion battery cells comprise at least one separator which separates the anode and the cathode both spatially and electrically from one another. The anode, the separator and the cathode can be rolled up into one another or be stacked on top of one another.

The cathode comprises, for example, a cathode support foil which is electrically conductive and comprises, for example, aluminum. The cathode active material, for example a combination of various lithium-metal oxides, is applied over at least part of the cathode support foil.

The anode comprises, for example, an anode support foil which is electrically conductive and comprises, for example, copper. The anode active material, which is, for example based on natural and/or synthetic graphites, is applied over at least part of the anode support foil.

The material of the separator comprises, for example, a polyolefin, in particular a polypropylene and/or a polyethylene, a fluorinated polyolefin, a polyimide, a polyamide, an alkane, a polytetrafluoroethylene, a polyvinylidene fluoride and/or a polyethylene terephthalate.

For incorporation and release processes for lithium ions to be able to take place in the electrodes, i.e. the anode and the cathode, a lithium ion conductor is required. This is provided in the form of an electrolyte.

The electrolyte comprises, for example, a mixture of acyclic carbonates (for example ethyl methyl carbonate, dimethyl carbonate or diethyl carbonate) or cyclic carbonates (for example ethylene carbonate or propylene carbonate) in which a conducting salt, for example, lithium hexafluorophosphate (LiPF₆), lithium perchlorate (LiClO₄), lithium hexafluoroarsenate (LiAsF₆) or lithium tetrafluoroborate (LiBF₄), has been dissolved.

During charging of lithium ion cells, lithium ions migrate from the cathode through the electrolyte to the anode and are incorporated into the latter. At the same time, electrons likewise migrate from the cathode to the anode via an external circuit. During discharging of lithium ion cells, these processes occur in the reverse direction, so that lithium ions migrate from the anode to the cathode and are incorporated into the latter.

As a result of an accident, for example an impact on the battery, as a result of very high or low temperatures or in the case of overcharging or deep discharge or in the case of contamination in the battery cell, for example with metal particles which have unintentionally got into the battery cell during production, the temperature in the interior of the battery cell can increase greatly. Once such a temperature increase has started, it is very difficult to stop. High temperatures in the battery cell lead, for example, to the electrolyte decomposing or to the separator shrinking. Such safety risks lead, for example, to gas formation and explosive release of the gas and also to a short circuit. To prevent such reactions, it is necessary to recognize such situations at an early juncture and promptly interrupt either the ion flow or the flow of the electric current.

In order to examine the safety of battery cells, use is made of, for example, the nail penetration test in which a nail is deliberately rammed into the battery cell so that the nail goes through the anode, the separator and also the cathode. These components of the battery cell are greatly damaged in this way. This situation simulates, for example, a severe internal short circuit of the battery cell. The reactions which take place as a result of the damaged regions can now be observed and analyzed. In the greatly damaged region of the battery cell, which is in the near vicinity of the nail, there is only a small electrical resistance as a result of which a very high current flows at this place. This in turn causes strong heating of the cell, which results in a temperature increase in the battery cell.

According to the invention, the cathode active material and/or the anode active material are/is structured in such a way that there are hollow spaces between contiguous cathode active material regions and/or between contiguous anode active material regions, and these spatially separate the contiguous cathode active material regions and/or the contiguous anode active material regions from one another. Here, the hollow spaces are at least partly filled with an electrically insulating material. The hollow spaces filled with electrically insulating material between contiguous cathode active material regions and/or between contiguous anode active material regions offer the advantage that the nail, during the nail penetration test, very probably also punches through these regions and not only through active material regions. Advantageous here is that the damage to the electrode composite is minimized since only the damaged active material regions are of importance rather than all regions adjoining the nail. It is particularly advantageous here that the electrical resistance in the regions of the electrode composite around the nail is higher in total, since electric current can flow only in the punctured active material regions but not in the punctured hollow spaces comprising electrically insulating material. Due to the higher electrical resistance around the region punctured by the nail compared to electrode composites having continuous active material, the flow of electric current around the nail is significantly minimized. As a result, the electric power loss of the battery cell is significantly lower than in the case of battery cells having continuous active material and the temperature around the damaged place increases less greatly. This is a critical advantage since when the temperature remains below a critical value, the probability of thermal runaway of the battery cell is significantly reduced. The term thermal runaway refers to overheating of the battery cell as a result of a self-reinforcing heating process which generally results in destruction of the battery cell. A further advantage is that the temperature increases more slowly compared to battery cells having continuous active material, so that, for example, further safety mechanisms such as quick discharge devices have more time to act in an emergency. Such a quick discharge device is disclosed, for example, in the document having the reference number 15193294.4 which had not yet been published at the date of filing of the present patent application.

Furthermore, the mechanical stability of the electrode composite comprising anode, separator and cathode is significantly increased by the hollow spaces being filled with electrically insulating material and the electrode composite cannot easily be deformed. As a result, the battery cell, for example, is long-life and stable. Even in the case of unwanted external influences, for example an accident or in the nail penetration test, the electrically insulating material offers additional protection since it keeps the cathode carrier foil and anode carrier foil at a distance from one another.

Further advantageous embodiments of the present battery cell are indicated in the dependent claims.

In one embodiment, the electrically insulating material is a polymer, for example a polyethylene terephthalate, a polyimide, a polyether ether ketone or a polypropylene. An advantage here is that the melting point of the polymers mentioned is higher than the operating temperature of the battery cell, as a result of which the safety of the battery cell is ensured.

In a further advantageous embodiment, the contiguous cathode active material regions and/or the contiguous anode active material regions have a repeating outline. A repeating outline has the advantages firstly that the production of the active material regions is very simple and that the same tool or the same machine can be used for this purpose. Furthermore, a repeating outline of the active material regions makes it simple to achieve a uniform arrangement of these on the respective support foil.

It is, for example, advantageous for the repeating outline to be in the form of round, triangular or rectangular, in particular square, anode active material regions and/or cathode active material regions. Such outlines make it possible to ensure a uniform arrangement of the active material regions on the respective support foil, so that it is highly probable that both active material regions and also hollow spaces filled with electrically insulating material will be struck in the event of puncture by a nail.

In an advantageous embodiment, the structured cathode active material and/or the structured anode active material is applied by means of screen printing to an anode foil and/or a cathode foil. It is advantageous here that the amount and also the structuring of the active material to be applied can be varied in this process. Furthermore, the screen printing process is economically profitable even in the case of large numbers of pieces.

In a further embodiment, it is advantageous for the hollow spaces to take up 25% of the area coated with anode active material and/or cathode active material. In the case of a 25% proportion by area of the hollow spaces, optimal distribution of active material regions and hollow spaces is achieved since the hollow spaces are small enough to keep the decrease in capacity of the battery cell resulting from the lack of active material regions small and nevertheless ensure that sufficient hollow spaces are present in order for these to be occasionally struck with high probability in the case of puncture by a nail.

In a particularly advantageous embodiment, the individual anode layers and/or cathode layers of the battery cell are arranged in such a way that the anode active material regions and/or cathode active material regions are offset relative to one another. Here, for example, the anode layers are offset relative to the cathode layers, so that the contiguous anode active material regions and the contiguous cathode active material regions are offset relative to one another. As an alternative or in addition, at least two anode layers are offset relative to one another and/or at least two cathode layers are offset relative to one another, so that the anode active material regions of different anode layers and/or the cathode active material regions of different cathode layers are offset relative to one another. A further alternative is for all electrode layers to be arranged randomly, so that the anode and cathode active material regions overlap randomly or are randomly offset relative to one another. When the individual anode layers and/or cathode layers of the battery cell are arranged in such a way that the anode active material regions and/or cathode active material regions are offset relative to one another, this has the advantage that the individual electrode layers have a different hollow space to active material region distribution at every position on the electrode assembly. As a result, the probability of the nail going through both active material regions and also filled hollow spaces is very high and the electrical resistance is thus likewise increased, giving the abovementioned advantages. When, for example, a nail penetrates into the electrode assembly in the nail penetration test, the active material region in one electrode layer is, for example, punctured, the region filled with electrically insulating material is punctured in another electrode layer and, for example, the nail adjoins an active material region and a filled hollow space in a further electrode layer. An advantage here is that no areal regions in which, for example, only active material regions are damaged on the one side of the nail and only filled hollow spaces are damaged on the other side of the nail extend over the electrode layers, but instead the damaged active material regions and filled hollow spaces alternate uniformly on all sides of the nail. This gives a very uniform distribution of the current flow at the damaged places since the electrical resistance does not decrease to a very low value in any place.

### BRIEF DESCRIPTION OF THE FIGURES

The figures show:

FIG. 1 a conventional electrode according to the prior art,

FIG. 2a a schematic depiction of an electrode of a battery cell according to the invention,

FIG. 2b the electrode of FIG. 2a in a cross section along the line A-A′,

FIG. 2c a schematic depiction of a first variant of he electrode depicted in FIG. 2a,

FIG. 2d a schematic depiction of a second variant of the electrode depicted in FIG. 2a,

FIG. 2e a schematic depiction of a third variant of the electrode depicted in FIG. 2a,

FIG. 3 a schematic depiction of a cross section through an electrode assembly according to the prior art in the nail penetration test,

FIG. 4a a schematic depiction of a cross section through an electrode assembly of a battery cell according to the invention in the nail penetration test in a first embodiment, and

FIG. 4b a schematic depiction of a cross section through an electrode assembly of a battery cell according to the invention in the nail penetration test in a second embodiment.

FIG. 1 shows an electrode according to the prior art. The electrode is, for example, an anode 1 or a cathode 3. The anode 1 or cathode 3 comprises an anode support foil 11 or cathode support foil 33, which is coated over part of its area with an anode active material 111 or a cathode active material 333. The region of the anode support foil 11 or cathode support foil 33 which does not have any coating serves for electrical contacting of the respective electrode and is, for example, welded to a power outlet lead.

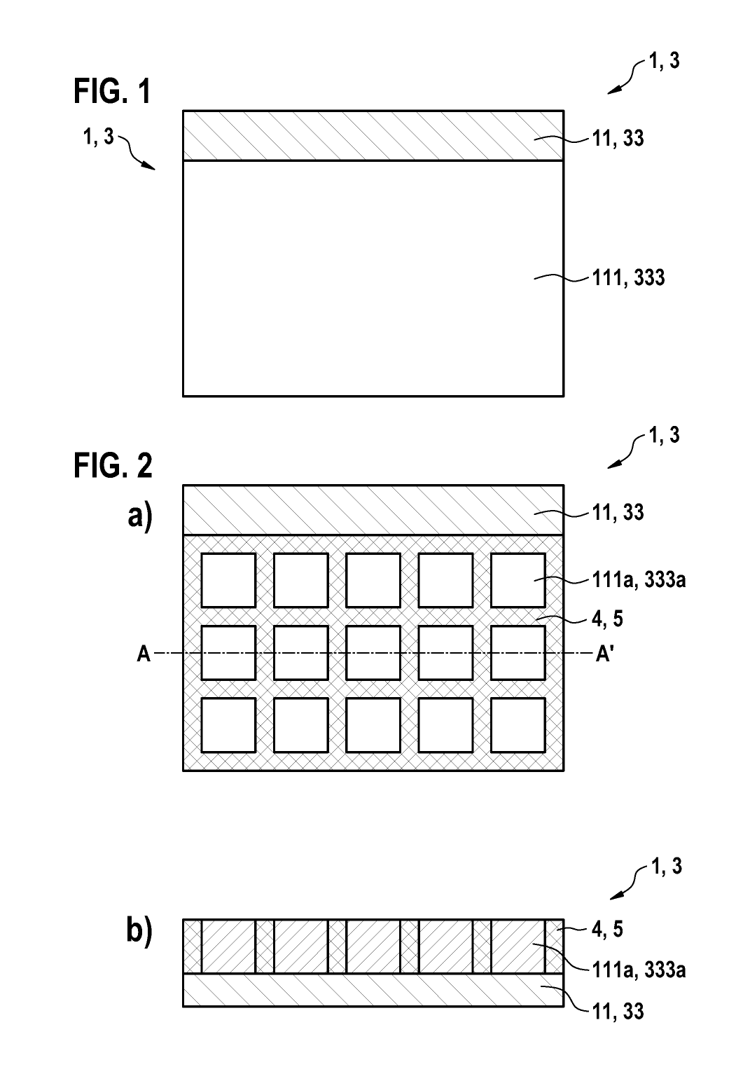

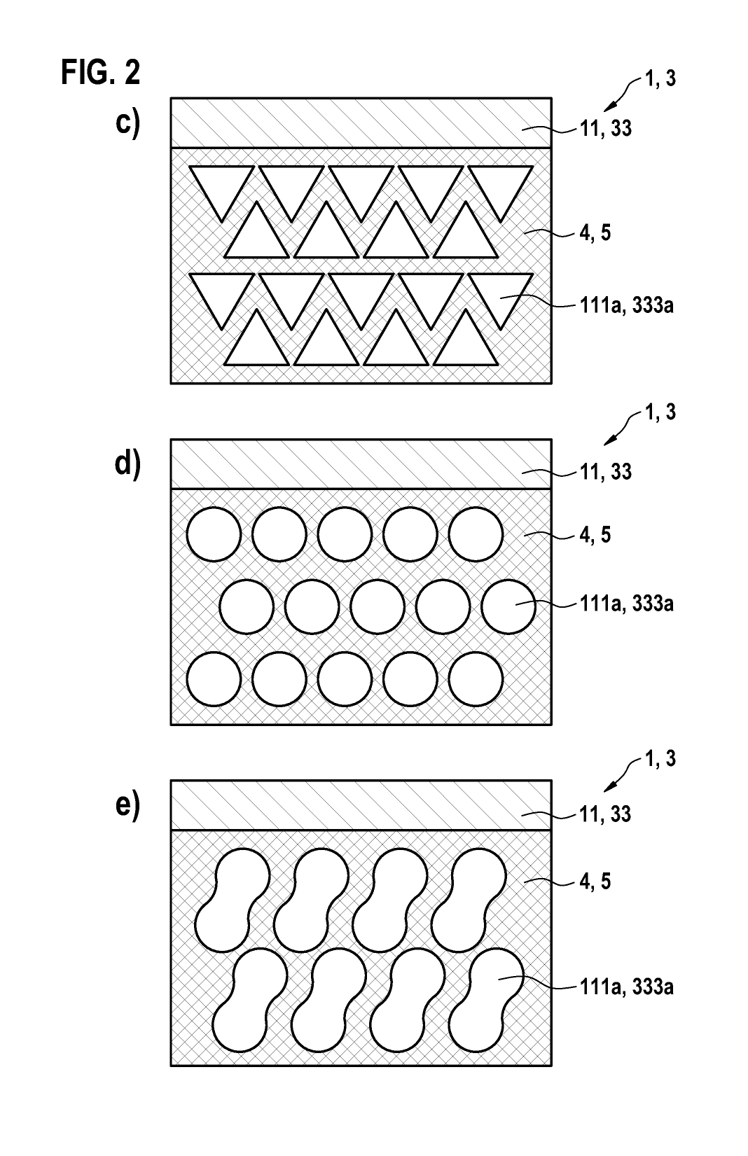

FIG. 2a shows an electrode of a battery cell according to the invention. In contrast to the conventional electrode as shown in FIG. 1, the anode active material 111 or the cathode active material 333 has not been applied over the area of the anode support foil 11 or the cathode support foil 33 but instead in regions, so that hollow spaces 4 are present between contiguous cathode active material regions 333a and between contiguous anode active material regions 111a. The hollow spaces 4 are filled with an electrically insulating material 5. The electrically insulating material 5 comprises, for example, a polyethylene terephthalate, a polyimide, a polyether ether ketone or a polypropylene.

In an alternative embodiment which is not shown, the hollow spaces 4 are only partly filled with an electrically insulating material 5. The outline of the cathode active material regions 333a and anode active material regions ilia is square and the square cathode active material regions 333a and anode active material regions 111a are arranged with equal spacings on the cathode support foil 33 or anode support foil 11. As an alternative, the outline of the cathode active material regions 333a or anode active material regions ilia is rectangular.

FIG. 2b depicts the electrode of FIG. 2a in a cross section along the line A-A′.

FIG. 2c depicts a first variant of the electrode shown in FIG. 2a. In contrast to FIG. 2a, the cathode active material regions 333a of the cathode 3 and the anode active material regions 111a of the anode 1 are not square but instead triangular.

FIG. 2d depicts a second variant of the electrode shown in FIG. 2a. In contrast to FIG. 2a, the cathode active material regions 333a of the cathode 3 and the anode active material regions 111a of the anode 1 are not square but instead round.

FIG. 2e depicts a third variant of the electrode shown in FIG. 2a. In contrast to FIG. 2a, the cathode active material regions 333a of the cathode 3 and the anode active material regions 111a of the anode 1 are not square but instead have a free shape. The shape depicted in FIG. 2e represents an example of any arbitrary shape.

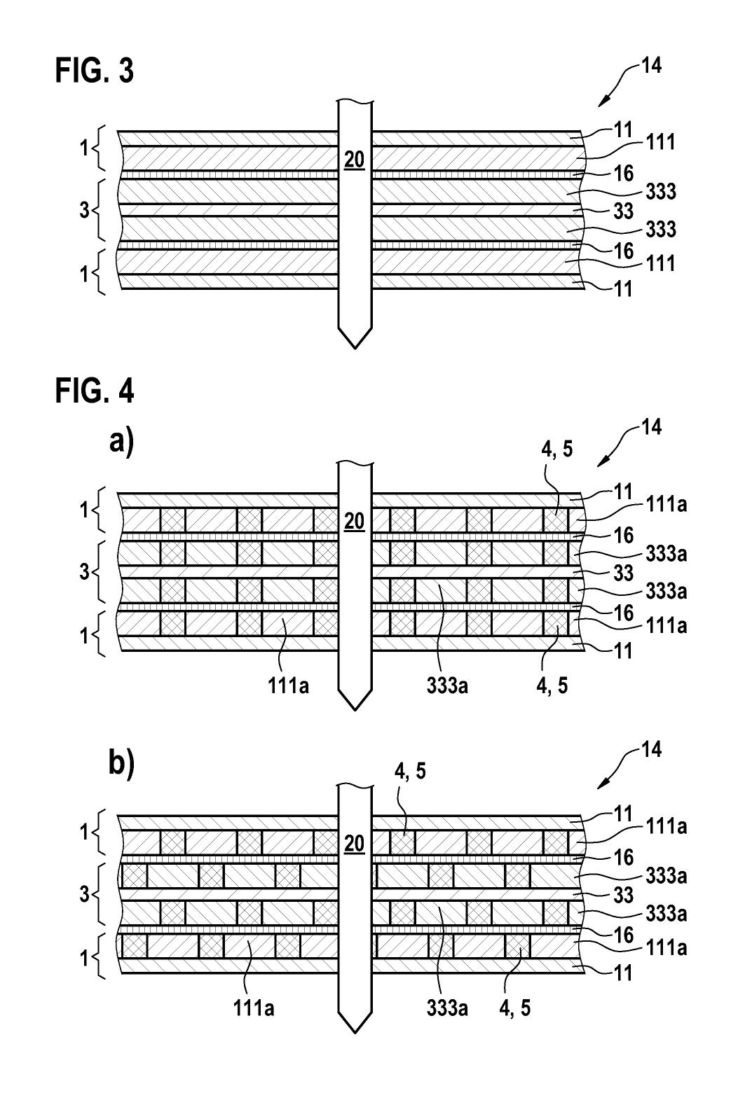

FIG. 3 discloses an electrode assembly 14 according to the prior art. The electrode assembly 14 comprises a cathode support foil 33 which is coated on both sides with a cathode active material 333. A separator 16 has been applied to each of the sides of the layers of the cathode active material 333 which face away from the cathode support foil 33. An anode active material 111 has been applied to each of the sides of the separators 16 which face away from the cathode active material 333. An anode support foil 11 has been applied to each of the sides of the anode active material 111 facing away from the separators 16. In an embodiment which is not shown, the electrode assembly 14 comprises further layers, for example further layers of the anode active material 111 on the anode support foil 11.

The cathode support foil 33 and the layers of the cathode active material 333 form the cathode 3, and the anode support foils 11 and the layers of the anode active material 111 form the anode 1. In FIG. 3, a cathode 3 is stacked in the specified order on an anode 1 and a further anode 1 is in turn stacked on the cathode 3. This is depicted only by way of example; further anodes 1 and cathodes 3 can be stacked on top of one another or there can be only one anode 1 and only one cathode 3. A separator 16 is in each case installed between an anode 1 and a cathode 3. This serves for spatial and electrical separation of the electrodes 1,3. In FIG. 3, a nail 20 has been pushed through the electrode assembly 14. This represents a critical situation and leads to unwanted reactions as have been described above in the disclosure of the invention.

FIG. 4a depicts an electrode assembly 14 of a battery cell according to the invention in a first embodiment. In contrast to FIG. 1, the anode active material 111 and the cathode active material 333 have not been applied over the full area of the anode support foil 11 and the cathode support foil 33 but instead only in regions as in FIG. 2, so that hollow spaces 4 are present between contiguous cathode active material regions 333a and between contiguous anode active material regions 111a. The hollow spaces 4 are filled with an electrically insulating material 5. The hollow spaces 4 which have been filled with electrically insulating material 5 in the layers of the anodes 1 and the cathode 3 are located directly above one another in FIG. 4a. Likewise, the cathode active material regions 333a and the anode active material regions 111a are located directly above one another. The nail 20 goes through the electrode assembly 14 in FIG. 4a in such a way that it adjoins superposed cathode active material regions 333a and anode active material regions 111a and also superposed hollow spaces 4 filled with electrically insulating material 5 in the electrodes 1, 3. Thus, not only are cathode active material regions 333a and anode active material regions 111a which are important for the function of the battery cell damaged, but regions which are unimportant for the function of the battery cell, namely the hollow spaces 4 filled with electrically insulating material 5, are also damaged. The advantages and improvements compared to conventional cells resulting therefrom have been described above in the disclosure of the invention.

FIG. 4b depicts an electrode assembly 14 of a battery cell according to the invention in a second embodiment. In contrast to the first embodiment depicted in FIG. 4a, the hollow spaces 4 filled with electrically insulating material 5 in the layers of the anode 1 and of the cathode 3 are not located above one another but instead are offset. Likewise, the cathode active material regions 333a and the anode active material materials 111a are not located above one another but instead are offset. In FIG. 4b, the electrode active material regions 111a, 333a of every second electrode layer are aligned above one another, so that a regular offset pattern is formed. The nail 20 goes through the electrode assembly 14 in FIG. 4b in such a way that it adjoins both cathode active material regions 333a and anode active material regions 111a and also hollow spaces 4 filled with electrically insulating material 5 in the electrodes 1, 3.

In an alternative embodiment which is not shown, the offset is not present in every second electrode layer but instead in every nth electrode layer, where n is any number.

In an alternative embodiment which is not shown, the anode active material regions 111a are offset relative to the cathode active material regions 333a.

In a further embodiment which is not shown, the anode active material regions 111a and the cathode active material regions 333a do not have the same length, so that an offset thereby results. Furthermore, as an alternative or in addition, the active material regions 111a, 333a of a single electrode layer do not have equal lengths.

In a further embodiment which is not shown, all electrode layers are arranged randomly, so that the electrode active material regions 111a, 333a overlap randomly.

In all embodiments, not only are cathode active material regions 333a and anode active material regions 111a which are important for the function of the battery cell damaged, but regions which are unimportant for the function of the battery cell, namely the hollow spaces filled with electrically insulating material 5, are also damaged. The advantages and improvements compared to conventional battery cells which result therefrom have been described above in the disclosure of the invention.

1. A battery cell, in particular lithium ion battery cell, having a cathode (3) comprising a cathode active material (333) and having an anode (1) comprising an anode active material (111), characterized in that the cathode active material (333) and/or the anode active material (111) is/are structured in such a way that between contiguous cathode active material regions (333a) and/or between contiguous anode active material regions (111a) there are hollow spaces (4) which spatially separate the contiguous cathode active material regions (333a) and/or the contiguous anode active material regions (111a) from one another and in that the hollow spaces (4) are at least partly filled with an electrically insulating material (5).

2. The battery cell as claimed in claim 1, characterized in that the electrically insulating material (5) is a polyethylene terephthalate, a polyimide, a polyether ether ketone or a polypropylene.

3. The battery cell as claimed in either of the preceding claims, characterized in that the contiguous cathode active material regions (333a) and/or the contiguous anode active material regions (111a) have a repeating outline.

4. The battery cell as claimed in claim 3, characterized in that the repeating outline is realized in the form of round, triangular or rectangular, in particular square, anode active material regions (111a) and/or cathode active material regions (333a).

5. The battery cell as claimed in any of the preceding claims, characterized in that the cathode active material regions (333a) and/or the anode active material regions (111a) have been applied to an anode support foil (11) and/or a cathode support foil (33) by means of screen printing.

6. The battery cell as claimed in any of the preceding claims, characterized in that the hollow spaces (4) take up 25% of the area coated with anode active material (111) and/or cathode active material (333).

7. The battery cell as claimed in any of the preceding claims, characterized in that individual anode layers and/or cathode layers of the battery cell are arranged in such a way that the anode active material regions (111a) and/or cathode active material regions (333a) are offset relative to one another.

8. A battery comprising at least one battery cell as claimed in any of claims 1-7.

9. The use of a battery as claimed in claim 8 in an electric vehicle, in a hybrid vehicle or in a plug-in hybrid vehicle.
